(19) United States
(12) Patent Application Publication
(10) Pub. No.: US 2025/0371245 A1
(43) Pub. Date: Dec. 4, 2025

(54) METHOD OF TRANSCRIBING TEXT OR SPOKEN WORDS INTO PROSODIC FONT

(71) Applicant: Richard MAZEL, Piedmont, CA (US)

(72) Inventor: Richard MAZEL, Piedmont, CA (US)

(21) Appl. No.: 19/221,645

(22) Filed: May 29, 2025

Related U.S. Application Data
(60) Provisional application No. 63/654,461, filed on May 31, 2024.

(51) Int. Cl. G06F 40/109; G06F 40/205; G06F 40/242; G10L 15/18; G10L 25/90

(52) U.S. Cl. CPC G06F 40/109; G06F 40/205; G06F 40/242; G10L 15/1807; G10L 25/90

(57) ABSTRACT

The present disclosure provides a method and system for transcribing text or a spoken stream of words into an output of prosodic font.

### CROSS-REFERENCE TO RELATED APPLICATION

This application claims the benefit of U.S. Provisional Application No. 63/654,461, filed May 31, 2024, which is hereby incorporated by reference in its entirety into the present application.

### BACKGROUND

Various linguistic methods can be used to teach a foreign language. However, the ability to read and understand words of a foreign language does not necessarily translate into the ability to speak in phrases, clauses, full sentences, and paragraphs, much less be fluent in conversation.

Prosody is the study of elements of speech that are not individual phonetic segments (vowels and consonants) but are properties of syllables and larger units of speech, including linguistic functions such as volume, speech rate, juncture, pitch, projection, stress ad intonation. Prosody is important because it signals linguistic information suprasegmental to the words—i.e., it provides information to the listener that goes beyond the simple meaning of each word.

Pronunciation of a particular language has a few overriding rules that govern the rhythm and pace of that spoken language, and one of the most important rules is vowel lengthening, which is rarely taught in association with learning a language. In every word that has importance to the speaker, there is usually one syllable whose vowel sound is lengthened, and that is in the stressed syllable. These important words, called “content words” in linguistics, are often nouns, adjectives, action verbs and adverbs.

### SUMMARY

The following brief summary is not intended to include all features and aspects of the present disclosure, nor does it imply that the disclosure must include all features and aspects discussed in this summary.

The present disclosure provides a method and system for transcribing text or a spoken stream of words into an output of prosodic font. The output can be used by a second language learner as an illustration of how a phrase or sentence would be spoken (e.g., what parts of the phrase or sentence would be emphasized) by a native speaker.

The foregoing and other objects, features and advantages of the disclosure will be apparent from the following more particular description of embodiments of the disclosure, as illustrated in the accompanying drawings in which like reference characters refer to the same parts throughout the different views. The drawings are not necessarily to scale, emphasis instead being placed upon illustrating the principles of the disclosure.

### BRIEF DESCRIPTION OF THE DRAWINGS

FIG. 1 shows components useful for transcribing text or a spoken stream of words into a prosodic font. The method may use a conventional computer keyboard (1) or laptop keyboard for inputting and processing the text to be spoken, the computer (2) (or laptop) having a conventional screen (3) and/or printer for displaying the font output. In one embodiment, the font output is termed a NewSpeaker Font™ output. FIG. 1 shows a method which takes a file of text (4) and parses it using a conventional computer keyboard (1) via a lexical parser (5). Words, phrases, and sentences are transformed into the NewSpeaker Font Browser Extension™ according to a set of phonological rules governing words and phrases based on a data bank containing a dictionary of words and their accented syllables. An htm, hmx, ccs and/or other markup language software program(s) (6) can be used to create the basic Speaking Font™ Document (7). The text is transformed by the lexical parser Font Transformer into the NewSpeaker Font™ Version Document (7) of the text. Spoken text can also be transformed into NewSpeaker Font Browser Extension™ by transforming the relative pitch frequencies of a spoken text directly into the speaker font. The prosodic details of a spoken stream of text and/or a computer-generated spoken stream are directly transformed according to the frequency of the pitch of words (8) within phrases in order to capture the actual prosody of a speaker or computer-generated speech via the language processing program (6) of the NewSpeaker Font Browser Extension™ text.

FIG. 2 shows the steps involved in generating a NewSpeaker Font™.

FIG. 3 shows how the word “apartment” could appear in prosodic font.

FIG. 4 shows how making the vowel longer not only occurs in words that the speaker deems important, but in phrases within sentences as well.

FIGS. 5A-5C show how a sentence would show contrastive stress in both bolded and in a larger font. FIG. 5C shows how, in a declarative sentence, the last word usually changes pitch from high to low and is indicated with an optional downward arrow or backslash (\).

FIG. 6A shows how a sentence can be transformed to indicate surprise. FIG. 6B shows how to indicate the rise in voice at the end of a yes/no question. FIG. 6C shows how, in singing, words like “about” can also receive emphasis.

FIG. 7A shows how to indicate a “glide” at the end of a sentence if it ends in a one-syllable word at the end of the sentence that goes from one tone to another, in the case of FIG. 7B, gliding downward. FIG. 7C shows how to indicate a “step” if it ends in a two or more-syllable word that goes from one tone to another in steps, starting from the stressed syllable.

FIG. 8A uses portions of the “I Have a Dream Speech” to show basic rules that are followed by the present disclosure: (1) lengthen syllables that are in bold; (2) shorten most other parts of the word and the “little grammar words” like pronouns, prepositions, articles, and conjunctions; and (3) pronounce each phrase as if it were a single word.

### DETAILED DESCRIPTION

Unless defined otherwise, all technical and scientific terms used herein have the same meaning as commonly understood by those of ordinary skill in the art to which this disclosure belongs. Although any methods and materials similar or equivalent to those described herein can be used in the practice or testing of the present disclosure, the preferred methods and materials are described. Generally, nomenclatures are those well-known and commonly used in the art. Certain experimental techniques, not specifically defined, are generally performed according to conventional methods well known in the art.

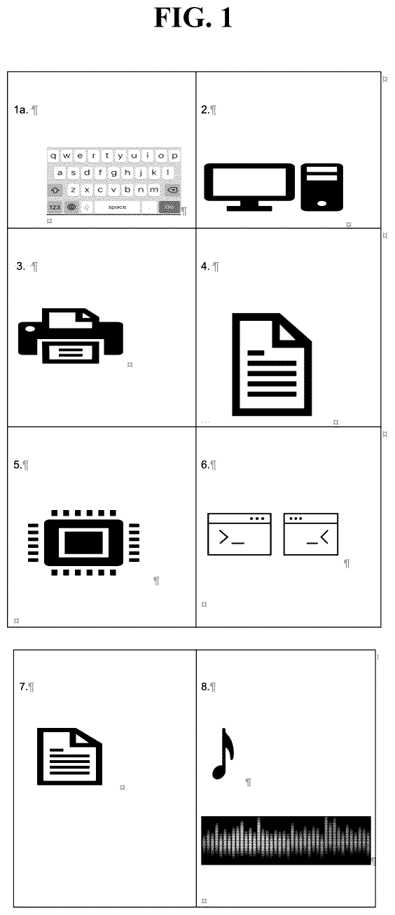

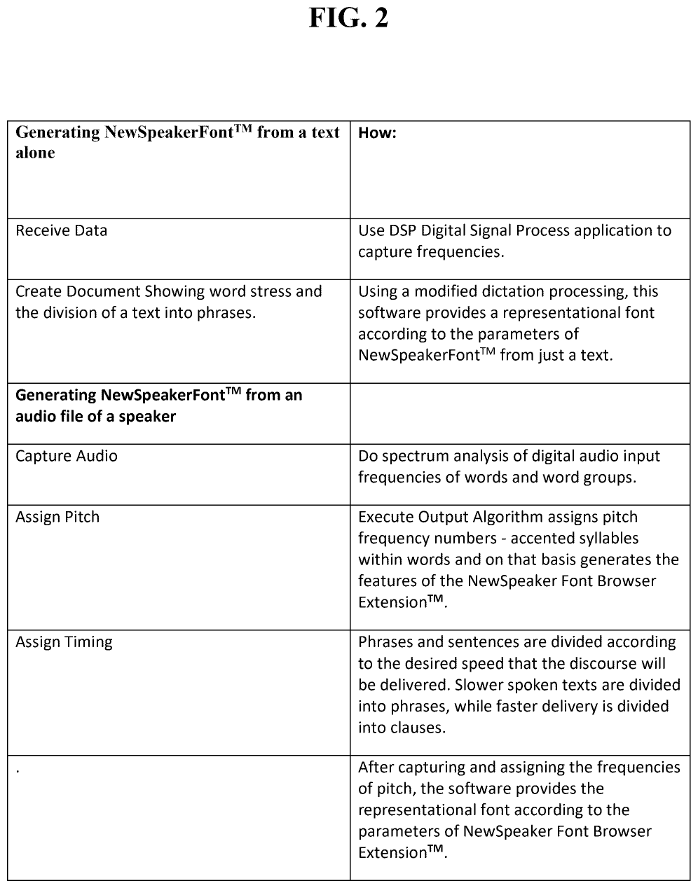

The disclosure provides a method and system for transforming text or spoken words into prosodic font. In one embodiment, the method and system are termed NewSpeaker™ and the output is termed NewSpeaker Font™. The method may use a conventional computer keyboard (1) or laptop keyboard for inputting and processing the text to be spoken, the computer (2) (or laptop) having a conventional screen (3) and/or printer for displaying the NewSpeaker Font™ output. The present disclosure includes a method of taking a file of text (4) and parsing it using a conventional computer keyboard (1) via a lexical parser (5). Words, phrases, and sentences are transformed into the NewSpeaker Font Browser Extension™ according to a set of phonological rules governing words and phrases based on a data bank containing a dictionary of words and their accented syllables. An htm, hmx, ccs and/or other markup language software program(s) (6) is used to create the basic Speaking Font™ Document (7). The text is transformed by the lexical parser Font Transformer into the NewSpeaker Font™ Version Document (7) of the text. Spoken text is also transformed into NewSpeaker Font Browser Extension™ by transforming the relative pitch frequencies of a spoken text directly into the speaker font. The prosodic details of a spoken stream of text and/or a computer-generated spoken stream is directly transformed according to the frequency of the pitch of words (8) within phrases in order to capture the actual prosody of a speaker or computer-generated speech via the language processing program (6) of the NewSpeaker Font Browser Extension™ text. See, FIGS. 1 and 2.

NewSpeakerFont™ works by showing at least 3 linguistic features in its transcription: (1) precisely where a speaker must lengthen syllables; (2) where a speaker connects words in phrases, and either pauses or stops phrases; and (3) where a speaker lowers or raises pitch. This is achieved by creating code that identifies these features in different ways. A first way is by a) using a bank of dictionary vocabulary words from which special bolding is applied to accented (lengthened) syllables; b) dividing the words into grammatical phrases using slashes; c) optionally underlining distinct phrases and clauses; and d) applying the basic rules of prosody by showing with differing slashes, arrows and/or steps either rising pitches, as for yes/no questions; or falling pitches, as for the ends of either statements or Wh-questions. A second way to accomplish the NewSpeaker Font Extension™ transcription is by applying an algorithm which performs a similar yet more precise transcription by transforming either spoken speech from an actual person or computer generated speech to the NewSpeaker Font Extension™ output.

The method and system (FIG. 2) receive data from a file of text using a digital signal process (DSP) application to capture frequencies. A document is created using a modified dictation processor, providing a representational font according to the parameters of NewSpeaker Font™, the document showing word stress and the division of a text into phrases.

The method and system (FIG. 2) can also generate NewSpeakerFont™ from an audio file of a speaker. Audio is captured and a spectrum analysis of the digital audio input frequencies of words and word groups is performed. Pitch is assigned by executing an output algorithm which assigns pitch frequency numbers and accented syllables within words, and on that basis will generate the features of the NewSpeaker Font Browser Extension™. Timing is assigned by dividing phrases and sentences according to the desired speed in which the discourse will be delivered. Slower spoken texts are divided into phrases, while faster delivery is divided into clauses. After capturing and assigning the frequencies of pitch, the software provides the representational font according to the parameters of NewSpeaker Font Browser Extension™.

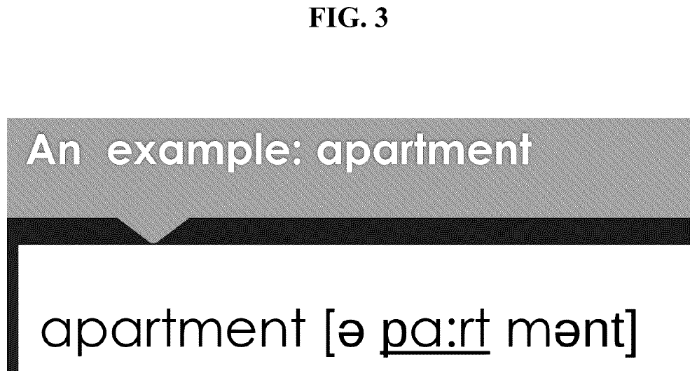

FIG. 3 shows how the word “apartment” could appear in prosodic font. The word “apartment” has one accented syllable (underlined here). Few people realize that the accented vowel here is also longer than the other vowels (lengthening is denoted by the colon.) It is also typically louder, clearer, and higher than the vowels in the other syllables. On the other hand, the vowel sound in unstressed syllables (the first and last here) are reduced or shorter: the “schwa” or the unstressed central vowel, represented by the symbol / [symbol] / in the International Phonetic Alphabet. These unstressed syllables are also less clear, weaker, and lower compared to the accented syllable. The schwa / [symbol] / is the most common sound in English because most unstressed vowels in long words are reduced to / [symbol] /.

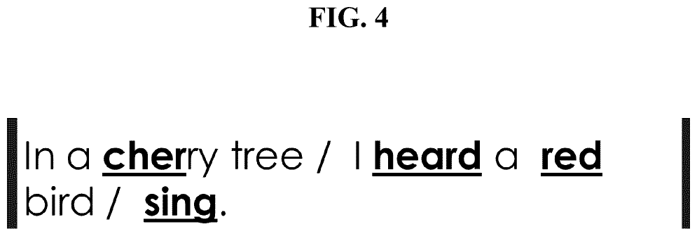

It turns out that the phenomenon of making the vowel longer not only occurs in words that the speaker deems important, but in phrases within sentences as well. Function words in each phrase, grammar words that typically hold the sentence together such as prepositions and articles, are shorter. Their vowel sounds are pronounced less clearly, less loudly, and lower than the stressed syllables. See, FIG. 4. Underlined word parts and words carry the stress of the phrase and are pronounced longer. The vowel sound in each of these underlined syllables is stretched. The NewSpeaker Font Browser Extension™ automatically bolds the stressed syllable(s) of the formerly underlined words so that a non-native speaker might easily pronounce a text more understandably to native speakers. NewSpeaker Font Browser Extension™ divisions between phrases are marked by a forward slash: “/”. In faster speech, no division between phrases is necessary.

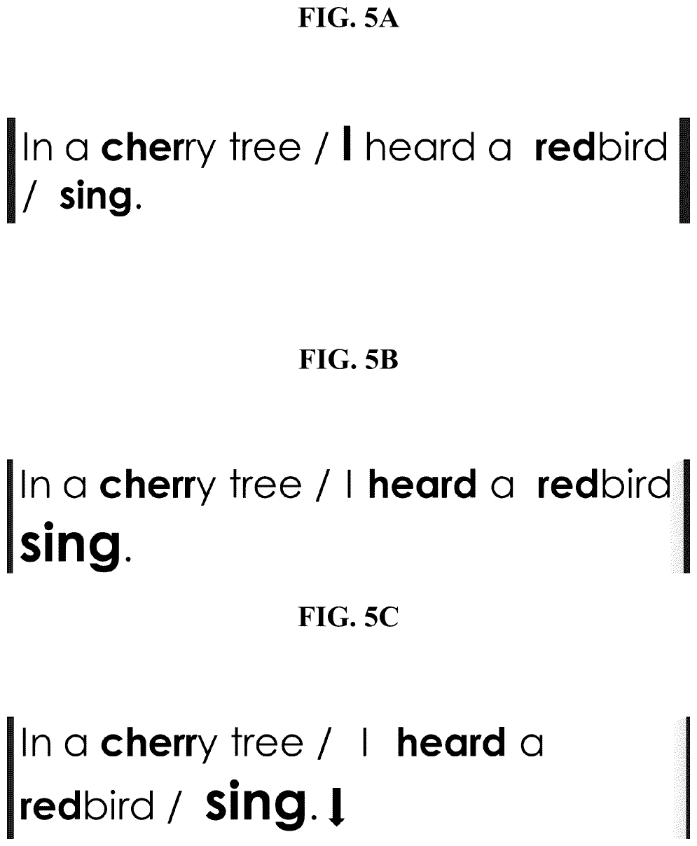

To show contrastive stress, a word is both bolded and in a larger font. In FIG. 5A, the word “I” becomes an important word and does not follow the normal stress pattern. Where the final stress is on the last important word of a sentence (more emphasized and lengthened), it can also be in larger font. See FIG. 5B. In a declarative sentence, the last word usually changes pitch from high to low. An optional downward arrow or backslash (\) can be used to indicate this. See FIG. 5C.

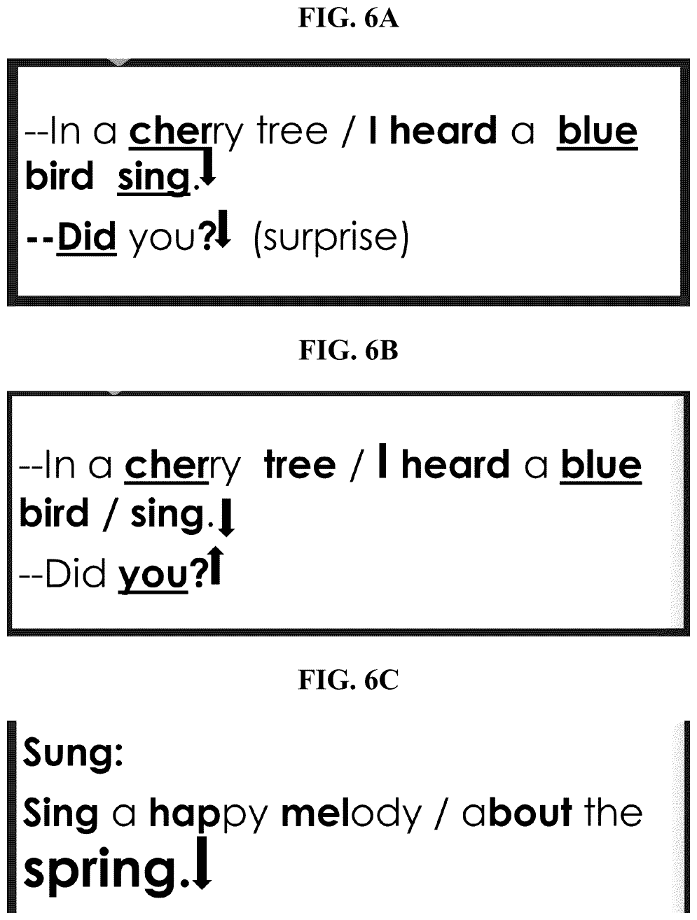

In another embodiment, the sentence can be transformed to indicate surprise (FIG. 6A) or the rise in voice at the end of a yes/no question (FIG. 6B). In singing, words like “about” can also receive emphasis (FIG. 6C).

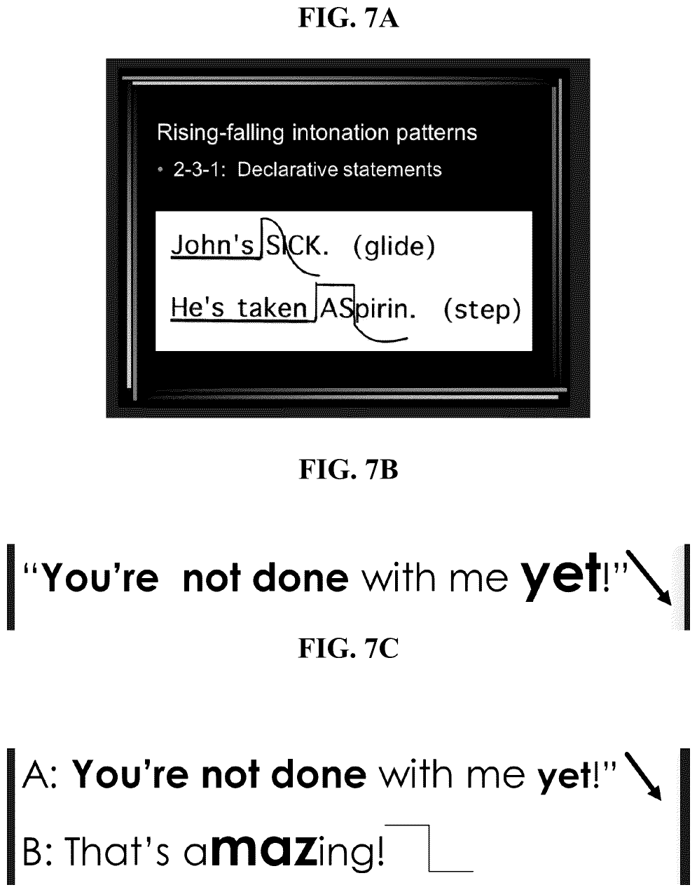

The present disclosure also provides for indication of a “glide” at the end of a sentence if it ends in a one-syllable word and “step” if it ends in a two or more syllable word. (FIG. 7A). A glide is a one syllable word at the end of the sentence that goes from one tone to another, in the case of FIG. 7B, gliding downward. A step is when a multi-syllable word goes from one tone to another in steps, starting from the stressed syllable. (FIG. 7C).

An extension on a browser as disclosed herein can help second language learners read and speak more understandably to native speakers but must take into account the pronunciation differences between the mother tongue of the student and the variety of English (or other language) of the native speaker. In one embodiment of the disclosure, the NewSpeaker Font Browser Extension™ is designed to allow second language learners whose native tongue is Swahili to read and speak more understandably to native speakers of North American English. In Swahili, words are pronounced separately, while in North American English, they are pronounced in phrases. In addition, the ends of sentences in English need to fall more to signal the end of a declarative sentence.

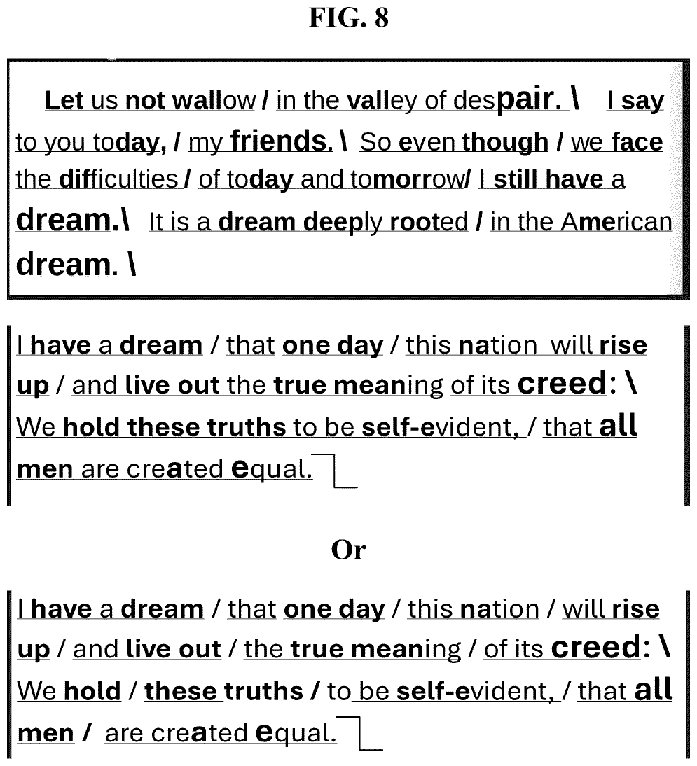

FIG. 8A uses portions of the “I Have a Dream Speech” to show basic rules that are followed by the present disclosure: (1) lengthen syllables that are in bold; (2) shorten most other parts of the word and the “little grammar words” like pronouns, prepositions, articles, and conjunctions; and (3) pronounce each phrase as if it were a single word.

In yet more detail, the present disclosure is described by the following items which represent preferred embodiments thereof.
1. A method for transcribing text into a prosodic font, comprising:
a. providing to a processor a file of text;
b. instructing the processor to parse the text via a lexical parser; and
c. instructing the processor to transform words, phrases, and sentences according to phonological rules into a speaking font document using a markup language software program.
2. The method of item 1, wherein the phonological rules are based on a data bank containing a dictionary of words and their accented syllables.
3. The method of item 1, wherein the markup language software program is an htm, hmx or ccs software program.
4. A method for transcribing a spoken stream of words into a prosodic font, comprising:
a. providing to a processor a file of spoken text; and
b. instructing the processor to transform relative pitch frequencies of the spoken text into speaker font, wherein prosodic details of the spoken text are transformed according to frequency of the pitch of words within phrases.
5. The method of item 4, wherein the prosody of the speaker is captured.
6. The method of item 5, wherein the speaker is a computer-generated voice.
7. A system for transcribing text into a prosodic font comprising a processor which is programmed to:
a. parse the text via a lexical parser;
b. transform words, phrases, and sentences according to phonological rules into a speaking font document using a markup language software program.
8. The system of item 7, wherein the phonological rules are based on a data bank containing a dictionary of words and their accented syllables.
9. The system of item 7, wherein the markup language software program is an htm, hmx or ccs software program.
10. A system for transcribing a spoken stream of words into a prosodic font, comprising a processor which is programmed to:
a. receive a file of spoken text; and
b. transform relative pitch frequencies of the spoken text into speaker font, wherein prosodic details of the spoken text are transformed according to frequency of the pitch of words within phrases.
11. The system of item 10, wherein the prosody of the speaker is captured.
12. The system of item 10, wherein the speaker is a computer-generated voice.
13. An output from the system of item 10, comprising a written diagram of one or more phrases or sentences, which indicates to a reader to:
a. lengthen syllables that are in bold;
b. shorten words like pronouns, prepositions, articles, and conjunctions; and
c. pronounce each phrase as if it were a single word.
14. The output of item 13, further comprising indications where phrases should be separated.
15. The output of item 13, further comprising an indication where the end of the sentence should show a rise in voice.
16. The output of item 13, further comprising an indication where the end of the sentence should show a drop in voice.
17. The output of item 13, further comprising indications where a multi-syllable word should be pronounced from one tone to another in a glide.
18. The output of item 13, further comprising indications where a multi-syllable word should be pronounced from one tone to another in steps.

Various changes and modifications to the disclosed embodiments will be apparent to those skilled in the art and such changes and modifications including, without limitation, those relating to the systems and/or methods of the disclosure may be made without departing from the spirit of the disclosure and the scope of the appended claims.

While this disclosure has been particularly shown and described with references to embodiments thereof, it will be understood by those skilled in the art that various changes in form and details may be made therein without departing from the scope of the disclosure encompassed by the appended claims.

1. A method for transcribing text into a prosodic font, comprising:
a. providing to a processor a file of text;
b. instructing the processor to parse the text via a lexical parser; and
c. instructing the processor to transform words, phrases, and sentences according to phonological rules into a speaking font document using a markup language software program.

2. The method of claim 1, wherein the phonological rules are based on a data bank containing a dictionary of words and their accented syllables.

3. The method of claim 1, wherein the markup language software program is an htm, hmx or ccs software program.

4. A method for transcribing a spoken stream of words into a prosodic font, comprising:
a. providing to a processor a file of spoken text; and
b. instructing the processor to transform relative pitch frequencies of the spoken text into speaker font,
wherein prosodic details of the spoken text are transformed according to frequency of the pitch of words within phrases.

5. The method of claim 4, wherein the prosody of the speaker is captured.

6. The method of claim 5, wherein the speaker is a computer-generated voice.

7. A system for transcribing text into a prosodic font comprising a processor which is programmed to:
a. parse the text via a lexical parser;
b. transform words, phrases, and sentences according to phonological rules into a speaking font document using a markup language software program.

8. The system of claim 7, wherein the phonological rules are based on a data bank containing a dictionary of words and their accented syllables.

9. The system of claim 7, wherein the markup language software program is an htm, hmx or ccs software program.

10. A system for transcribing a spoken stream of words into a prosodic font, comprising a processor which is programmed to:
a. receive a file of spoken text; and
b. transform relative pitch frequencies of the spoken text into speaker font,
wherein prosodic details of the spoken text are transformed according to frequency of the pitch of words within phrases.

11. The system of claim 10, wherein the prosody of the speaker is captured.

12. The system of claim 10, wherein the speaker is a computer-generated voice.

13. An output from the system of claim 10, comprising a written diagram of one or more phrases or sentences, which indicates to a reader to:
a. lengthen syllables that are in bold;
b. shorten words like pronouns, prepositions, articles, and conjunctions; and
c. pronounce each phrase as if it were a single word.

14. The output of claim 13, further comprising indications where phrases should be separated.

15. The output of claim 13, further comprising an indication where the end of the sentence should show a rise in voice.

16. The output of claim 13, further comprising an indication where the end of the sentence should show a drop in voice.

17. The output of claim 13, further comprising indications where a multi-syllable word should be pronounced from one tone to another in a glide.

18. The output of claim 13, further comprising indications where a multi-syllable word should be pronounced from one tone to another in steps.
